(19) United States
(12) Patent Application Publication
(10) Pub. No.: US 2024/0019075 A1
(43) Pub. Date: Jan. 18, 2024

(54) Floor Standing Panel Television Support Assembly

(71) Applicant: Jorge Davidson, Brooklyn, NY (US)

(72) Inventor: Jorge Davidson, Brooklyn, NY (US)

(21) Appl. No.: 17/863,954

(22) Filed: Jul. 13, 2022

(51) Int. Cl. F16M 11/26; F16M 11/42; F16M 11/10

(52) U.S. Cl. CPC F16M 11/26; F16M 11/42; F16M 11/10

(57) ABSTRACT

A floor standing panel television support assembly for a panel television includes a pair of bases, which is positionable on a substantially horizontal surface. Each post of a pair of posts is attached to and extends substantially vertically from a respective base. The post comprises a plurality of nested sections so that the post is selectively extensible. A mounting bracket is attached to and extends between the posts distal from the pair of bases. A panel television can be attached to the mounting bracket so that the panel television is mounted to the pair of posts. The posts transfer a load of the panel television to the bases.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to television support assemblies and more particularly pertains to a new television support assembly for a panel television. The present invention discloses a television support assembly providing a means for mounting a panel television without attachment to a wall, and wherein a height of the panel television from the floor is adjustable.

### (2) Description of Related Art Including Information Disclosed Under 37 CFR 1.97 and 1.98

The prior art relates to television support assemblies. Prior art television support assemblies may comprise wheeled consoles for cathode ray televisions, stands for panel televisions having one or two fixed length, straight or curved posts extending from a single wheeled base, mobile computer carts, and shelving units with panel television mounts attached. Many prior art television support assemblies have posts extending from a rear edge of a base with means attached to the posts distal from the bases that shift a center of gravity of an attached panel television to proximate to a center of the base. What is lacking in the prior art is a television support assembly comprising a pair of posts, which are selectively extensible and which extend from a pair of bases. A panel television can be attached to a mounting bracket attached to the posts so that a load of the panel television is transferred to the bases.

### BRIEF SUMMARY OF THE INVENTION

An embodiment of the disclosure meets the needs presented above by generally comprising a pair of bases, which is configured to be positioning on a substantially horizontal surface. Each post of a pair of posts is attached to and extends substantially vertically from a respective base. The post comprises a plurality of nested sections so that the post is selectively extensible. A mounting bracket is attached to and extends between the posts distal from the pair of bases. The mounting bracket is configured for attachment of a panel television so that the panel television is mounted to the pair of posts. The posts are configured to transfer a load of the panel television to the bases.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a floor standing panel television support assembly according to an embodiment of the disclosure.

FIG. 2 is a rear view in-use of an embodiment of the disclosure.

FIG. 3 is an in-use view of an embodiment of the disclosure.

FIG. 4 is a side in-use view of an embodiment of the disclosure.

### DETAILED DESCRIPTION OF THE INVENTION

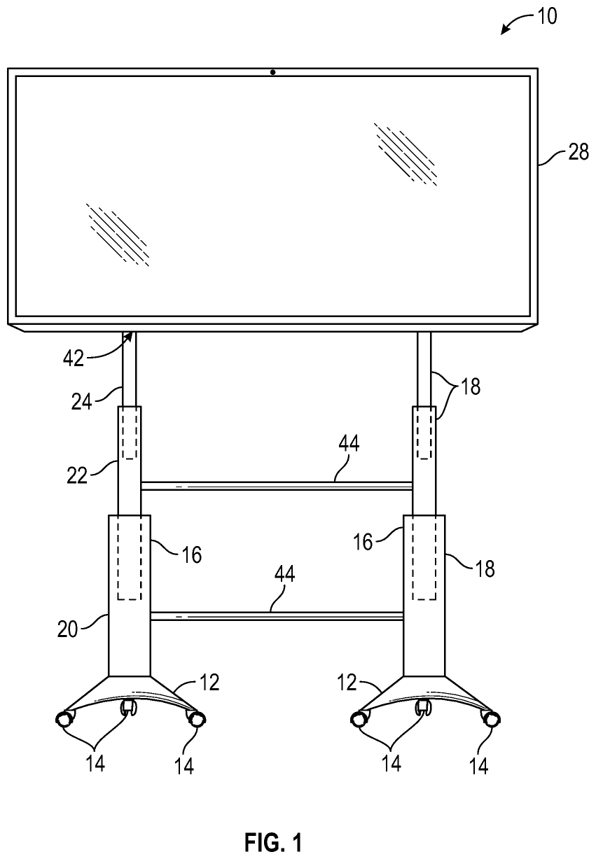

With reference now to the drawings, and in particular to FIGS. 1 through 4 thereof, a new television support assembly embodying the principles and concepts of an embodiment of the disclosure and generally designated by the reference numeral 10 will be described.

As best illustrated in FIGS. 1 through 4, the floor standing panel television support assembly 10 generally comprises a pair of bases 12, which is configured to be positioning on a substantially horizontal surface. As shown in FIG. 1, each base 12 is substantially triangular, although the present invention also anticipates the base 12 being square, circular, and the like. A plurality of castors 14 attached to the pair of bases 12 so that the bases 12 are rollable along the substantially horizontal surface. The present invention anticipates one or more of the castors 14 being lockable to prevent unintended movement of the bases 12.

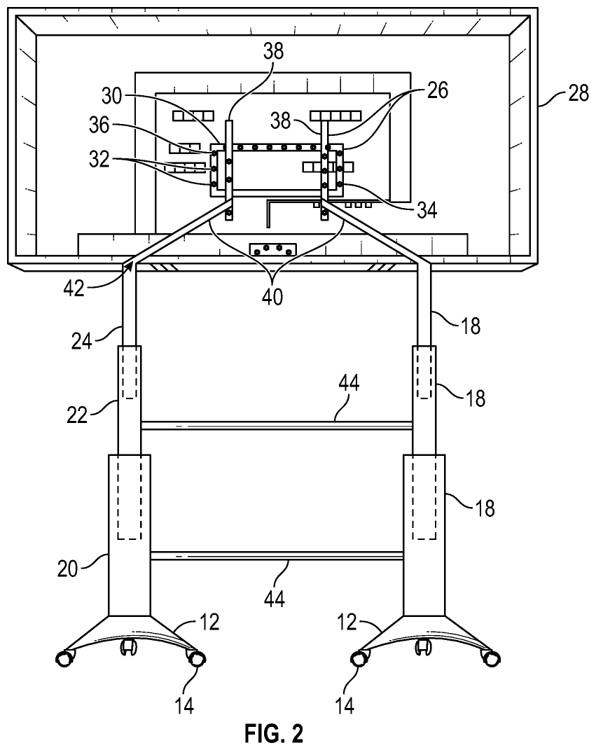

Each post 16 of a pair of posts 16 is attached to and extends substantially vertically from a respective base 12. The post 16 comprises a plurality of nested sections 18 so that the post 16 is selectively extensible. As shown in FIG. 2, the plurality of nested sections 18 comprises a lower section 20, which is attached to the respective base 12, a medial section 22, which is selectively extensible from the lower section 20, and an upper section 24, which is selectively extensible from the medial section 22.

A mounting bracket 26 is attached to and extends between the posts 16 distal from the pair of bases 12. The mounting bracket 26 is configured for attachment of a panel television 28 so that the panel television 28 is mounted to the pair of posts 16. The posts 16 are configured to transfer a load of the panel television 28 to the bases 12. Panel television 28, in the context of this specification, should be interpreted to mean liquid crystal displays, plasma displays, and the like. Brackets for mounting such displays typically entail mounting of the bracket to a wall. In some spaces where one would like to position a panel television 28, such as in an apartment, a rented office space, or the like, mounting of such brackets may be prohibited. Additionally, users have the option to easily reposition a panel television 28 mounted to the floor standing panel television support assembly 10, as the castors 14 allow for rolling. The plurality of nested sections 18 allows a vertical position of the panel television 28 to be optimized for a particular viewing environment.

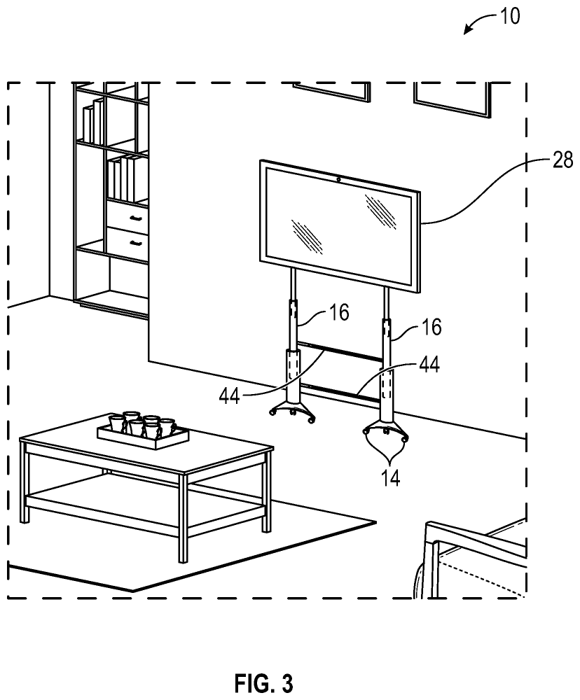

A variety of configurations of brackets for mounting a panel television 28 are known to those skilled in this art and are anticipated by the present invention. As shown in FIG. 2, the mounting bracket 26 comprises a rectangular frame 30, through which a plurality of through holes 32 is positioned. Respective through holes 32 are configured for insertion of bolts 34 for threaded insertion of the bolts 34 into corresponding mounting holes 36 in the panel television 28. The mounting bracket 26 also comprises a pair of tilt bars 38, which are attached to the rectangular frame 30 and allow for tilting of the panel television 28. As shown in FIG. 3, each arm of a pair of arms 40 is attached to and extends between an upper end 42 of a respective post 16 and an associated tilt bar 38.

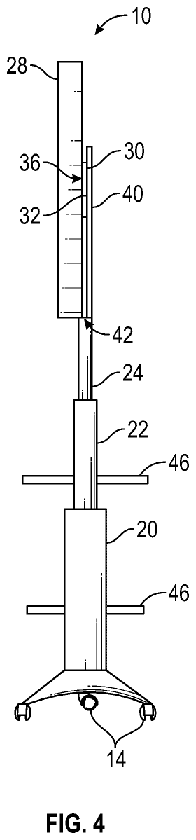

Each crossbeam 44 of a plurality of crossbeams 44 is attached to and extends between a respective nested section 18 of one of the posts 16 and an associated nested section 18 of the other of the posts 16. The crossbeam 44 extends perpendicularly between the posts 16 rigidifies the pair of posts 16 in a substantially parallel configuration. As shown in FIG. 4, the crossbeam 44 comprises a shelf 46, which is configured to stow an item, such as a digital video disc player, speaker, or the like.

In use, the floor standing panel television support assembly 10 is positioned proximate to a desired final location of the panel television 28. The panel television 28 then is attached to the mounting bracket 26 and the inputs and outputs of the panel television 28 are connected. The floor standing panel television support assembly 10 then can be rolled into its final location, often against a wall, as shown in FIG. 3. The plurality of nested sections 18 can be selectively extended to adjust a height of the panel television 28 relative to the substantially horizontal surface upon which the bases 12 are positioned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A floor standing panel television support assembly comprising:
a pair of bases configured for positioning on a substantially horizontal surface;
a pair of posts, each post being attached to and extending substantially vertically from a respective base, the post comprising a plurality of nested sections, such that the post is selectively extensible; and
a mounting bracket attached to and extending between the posts distal from the pair of bases, the mounting bracket being configured for attachment of a panel television, such that the panel television is mounted to the pair of posts, wherein the posts are configured for transferring a load of the panel television to the bases.

2. The floor standing panel television support assembly of claim 1, wherein each base is substantially triangular.

3. The floor standing panel television support assembly of claim 1, further including a plurality of castors attached to the pair of bases.

4. The floor standing panel television support assembly of claim 1, wherein the plurality of nested sections comprises:
a lower section attached to the respective base;
a medial section selectively extensible from the lower section; and
an upper section selectively extensible from the medial section.

5. The floor standing panel television support assembly of claim 1, further including a plurality of crossbeams, each crossbeam being attached to and extending between a respective nested section of one of the posts and an associated nested section of the other of the posts, such that the crossbeam extends perpendicularly between the posts, such that the plurality of crossbeams rigidifies the pair of posts in a substantially parallel configuration.

6. The floor standing panel television support assembly of claim 5, wherein the crossbeam comprises a shelf, wherein the shelf is configured for stowing of an item.

7. The floor standing panel television support assembly of claim 1, wherein the mounting bracket comprises:
a rectangular frame;
a plurality of through holes positioned in the rectangular frame, wherein respective through holes are configured for insertion of bolts for threaded insertion of the bolts into corresponding mounting holes in the panel television; and
a pair of tilt bars attached to the rectangular frame, wherein the tilt bars are configured for tilting of the panel television.

8. The floor standing panel television support assembly of claim 7, further including a pair of arms, each arm being attached to and extending between an upper end of a respective post and an associated tilt bar.

9. A floor standing panel television support system comprising:
a pair of bases configured for positioning on a substantially horizontal surface;
a pair of posts, each post being attached to and extending substantially vertically from a respective base, the post comprising a plurality of nested sections, such that the post is selectively extensible;
a mounting bracket attached to and extending between the posts distal from the pair of bases; and
a panel television mounted to the mounting bracket, wherein the posts are configured for transferring a load of the panel television to the bases.

10. A floor standing panel television support assembly comprising:
a pair of bases configured for positioning on a substantially horizontal surface, each base being substantially triangular;
a plurality of castors attached to the pair of bases;
a pair of posts, each post being attached to and extending substantially vertically from a respective base, the post comprising a plurality of nested sections, such that the post is selectively extensible, the plurality of nested sections comprising:
a lower section attached to the respective base,
a medial section selectively extensible from the lower section, and
an upper section selectively extensible from the medial section;
a plurality of crossbeams, each crossbeam being attached to and extending between a respective nested section of one of the posts and an associated nested section of the other of the posts, such that the crossbeam extends perpendicularly between the posts, such that the plurality of crossbeams rigidifies the pair of posts in a substantially parallel configuration, the crossbeam comprising a shelf, wherein the shelf is configured for stowing of an item;
a mounting bracket attached to and extending between the posts distal from the pair of bases, the mounting bracket being configured for attachment of a panel television, such that the panel television is mounted to the pair of posts, wherein the posts are configured for transferring a load of the panel television to the bases, the mounting bracket comprising:
a rectangular frame,
a plurality of through holes positioned in the rectangular frame, wherein respective through holes are configured for insertion of bolts for threaded insertion of the bolts into corresponding mounting holes in the panel television, and
a pair of tilt bars attached to the rectangular frame, wherein the tilt bars are configured for tilting of the panel television; and
a pair of arms, each arm being attached to and extending between an upper end of a respective post and an associated tilt bar.
